(19) United States
(12) Patent Application Publication
(10) Pub. No.: US 2023/0223018 A1
(43) Pub. Date: Jul. 13, 2023

(54) METHODS AND SYSTEMS FOR STREAMABLE MULTIMODAL LANGUAGE UNDERSTANDING

(71) Applicants: Chao XING, Montreal (CA); Anderson AVILA, Montreal (CA)

(72) Inventors: Chao XING, Montreal (CA); Anderson AVILA, Montreal (CA)

(21) Appl. No.: 17/571,425

(22) Filed: Jan. 7, 2022

(51) Int. Cl. G10L 15/197; G10L 15/22; G10L 15/18; G10L 15/16; G10L 19/00

(52) U.S. Cl. CPC G10L 15/197; G10L 15/22; G10L 15/1815; G10L 15/16; G10L 19/00; G10L 2015/223

(57) ABSTRACT

The present disclosure describes methods and systems for generating semantic predictions from an input speech signal representing a speaker's speech, and maps the semantic predictions to a command action that represents the speaker's intent. A streamable multimodal language understanding (MLU) system includes a machine learning-based model, such as a RNN model that is trained to convert speech chunks and corresponding text predictions of the input speech signal into semantic predictions that represent a speaker's intent. A semantic prediction is generated and updated, over a series of time steps. In each time step, a new speech chunk and corresponding text prediction of the input speech signal are obtained, encoded and fused to generate an audio-textual representation. A semantic prediction is generated by a sequence classifier by processing the audio-textual representation and the semantic prediction is updated as new speech chunks and corresponding text predictions are obtained. Extracted semantic information contained within a sequence of semantic predictions representing a speaker's speech are acted upon through a command action performed by another computing device or computer application.

### FIELD

The present disclosure relates to automatic speech recognition and natural language understanding, in particular methods and systems for streamable multimodal language understanding.

### BACKGROUND

Humans interact and communicate with computers in many ways, including typing on a keyboard, performing gestures on a touchscreen, or using voice commands. When using voice commands, a microphone connected to the computer typically captures a user's speech and transforms the captured speech into a digital signal that can be processed. Common applications for processed speech signals include text-to-speech conversion, speech-to-text or creating text transcripts, voice recognition for security or identification and interacting with digital assistants or smart devices.

Spoken language conveys concepts and meaning, as well as the speaker's intentions and emotions. Spoken language processing systems commonly receive a speech input from a user and determine what was said, for example, using an automatic speech recognition (ASR) module to transcribe speech to text may generate likely transcripts of an utterance. Spoken language processing systems may also receive a text transcript of an utterance, in order to determine the meaning of the text, for example using a natural language understanding (NLU) module to extract semantic information. However, it remains challenging for computers to accurately interpret intent or emotion associated with an utterance, using linguistic content alone. Intent and emotion may be communicated through semantic cues, or subtle cues in speech delivery such as timing, intensity, intonation and pitch, which are not generally captured within a text transcript of an utterance.

Current spoken language processing systems may also suffer from high latency because the NLU module needs to wait until an entire segment of the speech signal is processed by the ASR module before initiating processing of the text transcript generated for the segment of the speech signal.

Accordingly, it would be useful to provide a method and system for improving speech recognition and spoken language understanding to better capture a user's intent and reduce latency.

### SUMMARY

In various examples, the present disclosure describes a streamable multimodal language understanding (MLU) system which generates semantic predictions from an input speech signal representative of a speaker's spoken language, and maps the sematic predictions to a command action that represents a speaker's intent. The streamable MLU system includes a machine learning-based model, such as a neural network model, that is trained to convert speech chunks and corresponding text predictions of the input speech signal into semantic predictions that represents a speaker's intent. A semantic prediction is generated and updated, over a series of time steps. In each time step, a new speech chunk and corresponding text prediction of the input speech signal are obtained, encoded and fused to generate an audio-textual representation. A semantic prediction is generated by a sequence classifier by processing the audio-textual representation and the semantic prediction is updated as new speech chunks and corresponding text predictions are obtained. Semantic information extracted from a sequence of semantic predictions representative of a speaker's spoken language may then be acted upon through a command action performed by another computing device or computer application.

In some examples, the speech feature representations of the speech chunks and text feature representation of the text transcripts are fused into joint audio-textual representations that may be learned by a neural network of the streamable MLU system.

The streamable MLU system combines information from multiple modalities (e.g. speech chunks and text transcripts), for example, by fusing a feature representation of a speech chunk of a speech signal (i.e. emotion captured in frequency of speech) and the feature representation of a text transcript into a joint representation, which results in a better feature representation of a speaker's intent. Combining information from multiple modalities into a joint feature representation may enable additional semantic information to be extracted from the input speech signal to help to capture important semantic cues in speech chunks of the input speech signal that are not present in corresponding text transcripts.

A neural network included in the streamable MLU system is optimized to learn better feature representations from each modality (e.g. speech chunks and text transcripts), contributing to improved overall performance of the streamable MLU system. For example, an speech encoder subnetwork of the neural network is configured to process speech chunks is optimized to extract speech feature representations while a text encoder subnetwork of the neural network is configured to process text transcripts is optimized to extract text feature representations. Improved performance of the streamable MLU system may therefore be demonstrated by more accurately extracting a speaker's intent from a speaker's utterance.

In some examples, the streamable MLU system employs a sequence classification approach that allows the prediction and localization of multiple overlapping speech events, where a speech event may be a segment of an utterance (such as a word or a group of words) that carries meaning. Localization of semantic information may introduce more flexibility in intent extraction and semantic prediction and improve the performance of the streamable MLU system.

In some examples, the streamable MLU system includes an ASR module that operates in an online mode, or as a streamable ASR module. The streamable ASR module receives the input speech signal in real-time and generates speech chunks from the input speech signal in real-time, processes each speech chunk to generate a text prediction (e.g. a text transcript) corresponding to the speech chunk and provides the speech chunk and the corresponding text prediction to a language understanding module (for example, a MLU module).

In some examples, the streamable MLU system processes an input speech signal representing a speaker's speech for each speech chunk as it is received, rather than waiting to receive speech data for a full utterance, may reduce latency in the streamable MLU system. By receiving text transcripts for speech chunks rather than waiting for an speech signal to be transformed into a text transcript, the streamable MLU system may begin processing the input speech signal as soon as it is received and may update semantic predictions at every time step as a new speech chunk and corresponding text prediction are generated from the input speech signal and processed.

In some examples, the streamable MLU system generates a command action. The command action being instructed by one or more semantic predictions generated from an input speech utterance and based on a predefined set of commands.

In some aspects, the present disclosure describes a method for generating semantic predictions in order to execute a command action based on a predefined set of commands. The method comprises receiving, for a user's speech, a sequence of speech chunks and corresponding text transcripts; for each speech chunk and the corresponding text prediction for the speech chunk: encoding the speech chunk to generate an encoded representation of the speech chunk; encoding the text prediction to generate an encoded representation of the text prediction; synchronizing the encoded representation of the speech chunk and the encoded representation of the text prediction to generate a uniform representation; concatenating the uniform representation and the encoded representation of the text prediction to generate an audio-textual representation; and generating a semantic prediction based on the audio-textual representation; and transforming one or more of the semantic predictions into a command action based on a predefined set of commands.

In some aspects of the method, synchronizing the encoded representation of the speech chunk and the encoded representation of the text prediction comprises: computing attention weights between the encoded representation of the speech chunk and the encoded representation of the text transcript based on an attention mechanism; aligning the encoded representation of the speech chunk with a corresponding encoded representation of the text transcript based on the attention weights; and concatenating the e aligned encoded representation of the speech chunk and the corresponding encoded representation of the text transcript to generate the uniform representation.

In some aspects of the method, generating the semantic prediction based on the audio-textual representation comprises performing sequence classification on the audio-textual representation.

In some aspects of the method, generating the semantic prediction based on the audio-textual representation comprises performing sequence classification and localization on the audio-textual representation.

In some examples aspects of the method, each speech chunk in the sequence of speech chunks corresponds to a time step in a series of time steps.

In some examples aspects of the method, prior to receiving the user's sequence of speech chunks and corresponding text transcripts, the method further comprises: receiving a speech signal corresponding to the user's speech; generating a sequence of speech chunks based on the speech signal; encoding one or more encoded text features from each speech chunk; processing the one or more encoded text features using an attention mechanism to generate an attention-based text prediction corresponding to each speech chunk; processing the one or more encoded text features using connectionist temporal classification (CTC) to generate a CTC-based text prediction corresponding to each speech chunk; and generating a text prediction corresponding to each speech chunk.

In some aspects of the method, the semantic prediction is generated and updated for each subsequent speech chunk before the speech signal representative to the speaker's speech comprises an entire utterance.

In some aspects, the present disclosure describes a system. The system comprises a processor device and a memory stores machine-executable instructions which, when executed by the processor device, cause the device to perform any of the preceding example aspects of the method.

In some aspects, the present disclosure describes a non-transitory computer-readable medium having machine-executable instructions stored thereon which, when executed by a processor of a device, cause the device to perform any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram of a computing system that may be used for implementing a streamable multimodal language understanding (MLU) system, in accordance with example embodiments of the present disclosure;

FIG. 2 is a block diagram illustrating a streamable MLU system, in accordance with an example embodiment of the present disclosure;

FIG. 3 is a block diagram illustrating an Automatic Speech Recognition (ASR) module of the streamable MLU system of FIG. 2, in accordance with example embodiments of the present disclosure;

FIG. 4 is a block diagram illustrating a Multimodal Language Understanding (MLU) module of the streamable MLU system of FIG. 2, in accordance with example embodiments of the present disclosure; and

FIG. 5 is a flowchart of actions performed by the streamable MLU system, in accordance with example embodiments of the present disclosure.

### DETAILED DESCRIPTION

The following describes example technical solutions of this disclosure with reference to accompanying figures. Similar reference numerals may have been used in different figures to denote similar components.

In various examples, the present disclosure describes a streamable multimodal language understanding (MLU) system may include a machine learning-based model, such as a model based on a recurrent neural network (RNN) that is trained to convert speech chunks of an input speech signal representative of a speaker's spoken language and corresponding text transcripts of the input speech signal into a semantic prediction that represents the speaker's intent. A semantic prediction is generated and updated, over a series of time steps. In each time step, a new speech chunk and corresponding text prediction are obtained, encoded and fused to generate an audio-textual representation. A semantic prediction is generated by a sequence classifier and updated as new speech chunks and corresponding text transcripts are received. Semantic information extracted from a sequence of semantic predictions representative of a speaker's spoken language may then be acted upon through a command action performed by another computing device or computer application.

To assist in understanding the present disclosure, some existing techniques for processing speech signals representative of a speaker's spoken language, including automatic speech recognition (ASR) and natural language understanding (NLU), are now discussed.

Spoken language conveys concepts and meaning, as well as a speaker's intentions and emotions. Microphones are generally used to capture a speaker's spoken language and generate a speech signal representative of a speaker's spoken language (otherwise known as a speaker's utterance). Processing systems commonly employ various techniques to process a speech signal representative of a speaker's utterance to determine what was said by the speaker. To a processing system in determining what was said by a speaker, the processing system may use ASR to transcribe a speech signal representative of a speaker's utterance to text and generate a likely text transcript of the speaker's utterance. The processing systems may then analyze the text transcript of the speaker's utterance in order to determine the meaning of the text transcript, for example using a NLU. The processing system may use NLU to extract semantic information from the text transcript of the speaker's utterance. The extracted semantic information (which may be for example, a query, or an instruction) can be acted upon, for example by another computing device or a computer application.

Processing systems may commonly use ASR and NLU in tandem. However, because NLU techniques reply on receiving only linguistic content (for example, as a text transcript), it remains challenging for computers to accurately interpret intent or emotion in a text transcript generated from a speech signal representative of a speaker's utterance. Intent and emotion may be communicated through semantic cues, or subtle cues in speech delivery such as timing, intensity, intonation and pitch, which are not generally captured within a text transcript of speech signal representative of a speaker's utterance. Because common ASR techniques are not optimized to extract semantics from speech signals representative of a speaker's utterance when generating a text transcript, ASR techniques miss important semantic cues within the speaker's utterance. Errors in the text transcript generated using a ASR technique may also be propagated forward to when a NLU technique is used to extract semantic information from the text transcript of a speaker's utterance, which may hinder the accuracy of extracted semantic information.

Current processing systems may also suffer from high latency because such processing system need to wait until an entire speech signal representative of a speaker's utterance is processed before initiating processing of a text transcript generated for the entire the speech signal representative of a speaker's utterance.

The present disclosure describes examples that addresses some or all of the above drawbacks of existing techniques for processing speech signals representative of a speaker's spoken language.

To assist in understanding the present disclosure, the following describes some concepts relevant to neural networks, and particularly recurrent neural networks (RNNs) and for the purpose of speech processing and semantic prediction, along with some relevant terminology that may be related to examples disclosed herein.

A recurrent neural network (RNN) is a neural network that is designed to process sequential data and make predictions based on processed the sequential data. RNNs have an internal memory that remembers inputs (e.g. the sequential data), thereby allowing previous outputs (e.g. predictions) to be fed back into the RNN and information to be passed from one time step to the next time step. RNNs are commonly used in applications with temporal components such as speech recognition, text translation, and text captioning.

RNNs may employ a long short-term memory (LSTM) which contain “cells”. The cells employ various gates (for example, input gate, output gate and a forget gate) which facilitate long-term memory and control the flow of information needed to make predictions.

In the present disclosure, a “speech signal” or an “acoustic signal” is a non-stationary electronic signal that carries linguistic information from one or more utterances in a speaker's speech. An utterance is a unit of a speaker's speech including the vocalization of one or more words or sounds that convey meaning. Utterances may be bounded at the beginning and the end with a pause or period of silence and may include multiple words.

In the present disclosure, a “speech chunk” is a segment of a speech signal. A speech chunk is processed (for example, with an 80-dimensional log Mel Filter bank) to extract a sequence of speech features. In some examples, a speech chunk may be a segment of a speech signal with a set length. A speech chunk may represent part of a word within an utterance of words. In some examples, speech features may be referred to as speech embeddings.

In the present disclosure, “embeddings” are defined as low-dimensional, learned representations of discrete variables as vectors of numeric values. They represent a mapping between discrete variables and a vector of continuous numbers and are learned for neural network models. In some examples, embeddings may be referred to as embedding vectors.

In some examples, a neural network model may include into two parts, the first being an encoder subnetwork and the second being a decoder subnetwork. An encoder subnetwork is configured to convert data (e.g. a speech chunk or a text transcript) into a sequence of representations (otherwise referred to as embeddings) having a defined format, such as a vector of fixed length. For example, an encoder subnetwork may be configured to convert a speech chunck into a sequence of feature representations. A decoder subnetwork is configured to map the feature representation to an output to make accurate predictions for the target.

In the present disclosure, an “encoded representation” is a collection of encoded feature representations (otherwise referred to as encoded feature embeddings) resulting from encoding performed by, for example, an encoder subnetwork, which may be feed forward neural network. In machine learning, an encoder may extract a set of derived values (i.e. features) from input data, such that the derived values contain information that is relevant to a task performed by the feed forward neural network, often with reduced dimensionality compared to the input data. In the present disclosure, an “encoded representation of a speech chunk” is a collection of encoded feature representations (i.e. encoded feature embeddings) corresponding to a sequence of speech chunks. In other examples, an “encoded representation of a text prediction” is a collection of encoded word embeddings corresponding to a sequence of words in a text transcript of a speech chunk.

In the present disclosure, “feature fusion” is defined as the consolidation of feature representations (i.e. feature embeddings) from different sources, such as such as speech chunks and text transcripts, into a single joint feature representation or embedding. By fusing feature representations (i.e. feature embeddings) from different sources into a single feature representation or embedding improves the performance of a SLU system of the present disclosure.

In the present disclosure, a “speech event” or a “semantic event” is defined as a segment of an utterance (such as a word or a group of words) that carries meaning. Words that correspond to certain parameters (such as a destination, a date or an object) may be considered a “slot event” whereas words that convey intent may be considered an “intent event.” In spoken language understanding (SLU), the process of slot filling is commonly used to apply labels to contiguous words that carry meaning, however challenges arise when sequences of words can have different meanings depending on the context or how the words are ordered. An “overlapping event” may be defined as utterances that include multiple categories of semantic information spanning overlapping groups of words. An example of an overlapping event may be an utterance such as “turn the light on,” where the object “the light” represents the slot event that overlaps the speaker's intent event “turn on”.

In the present disclosure, “semantic prediction” is a prediction of a speaker's intent, based on semantic information extracted from audio-textual representations of a sequence of speech chunks. Knowledge of perceived words in a text transcript generated from a speech chunk of a speech signal representative of a speaker's utterance can be used to facilitate a prediction of upcoming words and proactively predict speaker's intent. A semantic prediction may constitute an instruction that may result in an action being taken by another computing device or computer application. The semantic prediction may include multiple semantic events, where the semantic events include a combination of slot events and intent events.

In the present disclosure, “command action” is an action performed by another computing device or computer application. For example, a command action associated with the semantic prediction “turn the lights on” would cause a computing device or computer application which controls the lights of a room to turn on the lights in the room. A command action associated with the semantic prediction “play a song” would cause another computing device or computer application to play a song.

In the present disclosure, “online mode” is a mode of operation where a SLU system may simultaneously receive and process device speech signal representative of a speaker's speech as the speaker signal is received from a microphone that captures the speaker's speech. For example, an ASR module operating in “online mode” may receive a speech signal corresponding to a user's speech in real-time, in the form of speech chunks rather than an entire speech signal representing a full utterance by a speaker, and may process the received speech chunk while simultaneously receiving new speech chunks of speech signal to be processed.

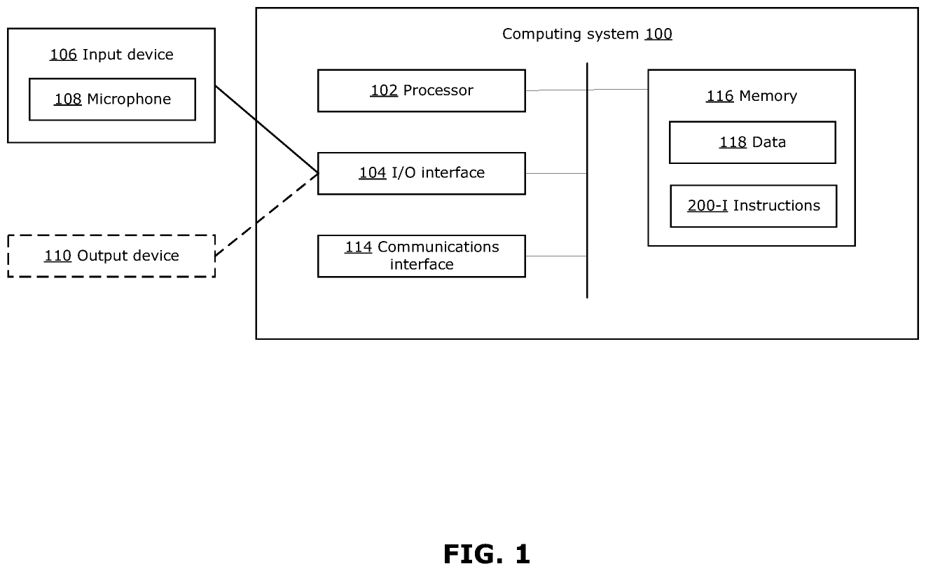

FIG. 1 shows a block diagram of an example hardware structure of a computing system 100 that is suitable for implementing embodiments of the system and methods of the present disclosure, described herein. Examples of embodiments of system and methods of the present disclosure may be implemented in other computing systems, which may include components different from those discussed below. The computing system 100 may be used to execute instructions to carry out examples of the methods described in the present disclosure. The computing system 100 may also be used to train the RNN models of the streamable MLU system 200, or the streamable MLU system 200 may be trained by another computing system.

Although FIG. 1 shows a single instance of each component, there may be multiple instances of each component in the computing system 100.

The computing system 100 includes at least one processor 102, such as a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 100 may include an input/output (I/O) interface 104, which may enable interfacing with an input device 106 and/or an optional output device 110. In the example shown, the input device 106 (e.g., a keyboard, a mouse, a camera, a touchscreen, and/or a keypad) may also include a microphone 108. In the example shown, the optional output device 110 (e.g., a display, a speaker and/or a printer) is shown as optional and external to the computing system 100. In other example embodiments, there may not be any input device 106 and output device 110, in which case the I/O interface 104 may not be needed.

The computing system 100 may include an optional communications interface 114 for wired or wireless communication with other computing systems (e.g., other computing systems in a network). The communications interface 114 may include wired links (e.g., Ethernet cable) and/or wireless links (e.g., one or more antennas) for intra-network and/or inter-network communications.

The computing system 100 may include one or more memories 116 (collectively referred to as “memory 116”), which may include a volatile or non-volatile memory (e.g., a flash memory, a random access memory (RAM), and/or a read-only memory (ROM)). The non-transitory memory 116 may store instructions for execution by the processor 102, such as to carry out example embodiments of methods described in the present disclosure. For example, the memory 116 may store instructions for implementing any of the systems and methods disclosed herein. The memory 116 may include other software instructions, such as for implementing an operating system (OS) and other applications/functions.

The memory 116 may also store other data 118, information, rules, policies, and machine-executable instructions described herein, including a speech signal representative of a speaker's utterance captured by the microphone 108 or speech signal representative of a speaker's utterance captured by a microphone on another computing system and communicated to the computing system 100.

In some examples, the computing system 100 may also include one or more electronic storage units (not shown), such as a solid state drive, a hard disk drive, a magnetic disk drive and/or an optical disk drive. In some examples, data and/or instructions may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 116 to implement data storage, retrieval, and caching functions of the computing system 100. The components of the computing system 100 may communicate with each other via a bus, for example.

Although the computing system 100 is illustrated as a single block, the computing system 100 may be a single physical machine or device (e.g., implemented as a single computing device, such as a single workstation, single end user device, single server, etc.). The computing system may be a mobile communications device (smartphone), a laptop computer, a tablet, a desktop computer, a smart speaker, a vehicle driver assistance system, a smart appliance, a wearable device, an assistive technology device, an Internet of Things (IoT) device, edge devices, among others. In some embodiments, the computing system 100 may comprise a plurality of physical machines or devices (e.g., implemented as a cluster of machines, server, or devices). In some embodiments, the computing system 100 may be a virtualized computing system (e.g., a virtual machine, a virtual server) emulated on a cluster of physical machines or by a cloud computing system.

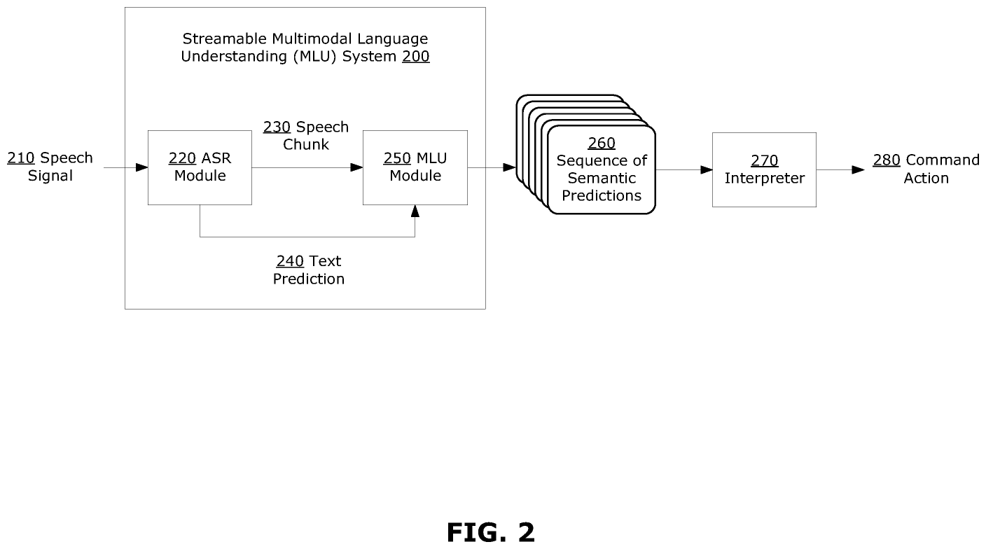

FIG. 2 shows a block diagram of an example Streamable Multimodal Language Understanding (MLU) system 200 of the present disclosure. The streamable MLU system 200 may be a software that is implemented in the computing system 100 of FIG. 1, in which the processor 102 is configured to execute instructions 200-I of the streamable MLU system 200 stored in the memory 116. The streamable MLU system 200 includes an automated speech recognition module 220 and a multimodal language understanding module 250.

The streamable MLU system 200 receives an input of a speech signal 210 representative of a speaker's speech and generates and outputs a sequence of semantic predictions 260 that may be transformed into a command action 280. The speech signal 210 may be generated in real-time by a microphone 108 of the computing system 100 as the microphone 108 captures a speaker's speech or may be generated by the microphone 108 and stored in memory 116 of the computing system for retrieval by the streamable MLU system 200. Alternately, the speech signal 210 may be generated by another microphone, such as a microphone of another electronic device, and the speech signal 210 may be communicated by the another electronic device to the computing system 100 for processing using the streamable MLU system 200. For example, the computing system 100 may provide a streamable MLU system as service to other electronic devices to generate semantic predictions, which can be transformed by the other electronic device into a command action 280. The speech signal 210 may be continuously received and may be representative of a speaker's speech that includes one or more utterances.

In some examples the streamable MLU system 200 may iteratively generate the sequence of semantic predictions 260. The semantic predictions 260 may be transformed by an interpreter 270 into a command action 280 based on a predefined set of commands. A computing system or computer application running on a computing system that is capable of executing the predefined command action 280 may then be able to execute the command action 280. In an example embodiment, a speaker may utter a voice command such as “turn the lights on”, which may then be received as a speech signal 210 by the computing system 100, such as a smart speaker, implementing the SLU system 200. The streamable MLU system 200 may process the speech signal 210 to output a semantic prediction 260 that captures the speaker's intent to “turn on” “the lights”. The smart speaker may then be able to map the semantic prediction to a command action 280 from a predefined set of command actions that the user wishes to turn on the lights, and may execute the command action 280.

The Streamable MLU system 200 includes a speech signal 210 may be provided to an Automatic Speech Recognition (ASR) module 220 to generate a sequence of speech chunks 230 and a text transcript 240.

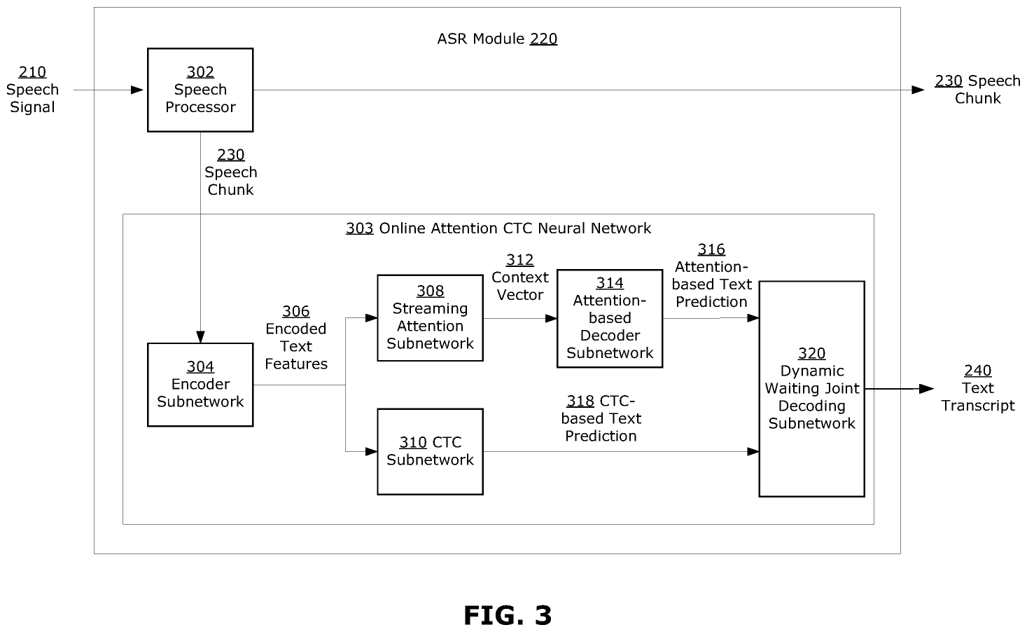

FIG. 3 is a block diagram of an example embodiment of the ASR module 220, in accordance with the present disclosure. The ASR module 220 receives a speech signal 210 representative of a speaker's speech and generates a sequence of speech chunks 230 and corresponding text transcripts 240 from the speech signal 210. In some example embodiments, the ASR module 220 may be an online ASR or a streamable ASR, where an ASR operating in an online mode may receive a speech signal in real-time (i.e. as a speech signal representative of a speaker's speech is generated by a microphone) and process the received speech signal in real time (i.e. as the speech signal is received).

The ASR module 220 includes a speech processor 302 that generates a sequence of speech segments from the speech signal 210 representative of a speaker's speech. For example, the speech signal 210 received from the microphone 108 may be divided into segments of 320 samples (e.g. segment with a 20 ms window length) and shifted with a step size of 160 samples (e.g. a hop-size of 10 ms). Each segment may then be sampled at 16 kHz and filtered using an 80-dimensional log Mel filter bank to extract a sequence of speech features, denoted as X={x₁, . . . , x_{T}}, where X represents a speech chunk 230 and T represents the number of segments. A sequence of speech chunks 230 may then be output from the speech processor 302.

The ASR module 220 also includes an online attention CTC neural network 303 that includes an encoder subnetwork 304, a streaming attention subnetwork 308, a Connectionist Temporal Classification (CTC) subnetwork 310, an attention-based decoder subnetwork 314, and a dynamic waiting joint decoding subnetwork 320. The encoder subnetwork 304 is configured to receive the sequence of speech chunks 230 generated by the speech processor 302 and generate a sequence of encoded text features 306, denoted as H={h₁, . . . , h_{L}} of length L, where L≤T. The sequence of encoded text features 306 may then be fed into the streaming attention subnetwork 308 and the CTC subnetwork 310. The CTC subnetwork 310 is configured to apply a Connectionist Temporal Classification (CTC) mechanism to the sequence of encoded text features 304. In this way, the ASR module 220 includes a neural network that has a hybrid CTC/attention architecture. An example of a hybrid CTC/attention architecture is described in: Miao, Haoran, et al., “Online hybrid ctc/attention end-to-end automatic speech recognition architecture,” IEEE/ACM Transactions on Audio, Speech, and Language Processing 28 (2020): 1452-1465. The online attention CTC neural network 303 enables the processing of each speech chunk 230 as it is received from the encoder 304, rather than waiting to receive an entire sequence of speech chunks. In this way, the online attention CTC neural network 303 enables the operation of the ASR module 220 is a streamable or online mode. In some examples, performing ASR on each speech chunk 230 may reduce latency associated with ASR performed on entire utterances.

The streaming attention subnetwork 308 may receive the encoded text features 306 for each speech chunk 230, the encoded text features 306 including a series of hidden states for a previous output time step i−1. The streaming attention subnetwork 308 then processes the encoded text features 306 using an attention mechanism to generate a context vector 312 for an output time step i, for each speech chunk, denoted by cᵢ.

The attention-based decoder subnetwork 314 receives the context vector 312 from the streaming attention subnetwork 308 and output sequence of target class labels Y={y₁, . . . , yₙ} as a prediction at each time step. The attention-based decoder subnetwork 314 may also output a new hidden state for the current time step t, which may be fed back to the attention-based decoder subnetwork 314 for generating attention based text transcripts 316 for the next time step (i.e., for time step t+1). In some example embodiments, the attention-based decoder subnetwork 314 may be a unidirectional LSTM. In other example embodiments the attention-based decoder subnetwork 314 may be a bidirectional LSTM. The attention-based decoder subnetwork 314 may use as inputs, the context vector 312 cᵢ₋₁ for the output time step i−1 along with hidden state sᵢ₋₁ of the encoded text features 306 at time i−1 and previous target labels yᵢ₋₁ for output time step i−1. The relationships between the encoder subnetwork 304, streaming attention subnetwork 308 and attention-based decoder subnetwork 314 in the online attention CTC neural network 303 of the ASR module 220 may be described by the following equations:

H=Encoder(X) 1

cᵢ=Attention(sᵢ₋₁,H) 2

yᵢ=Decoder(sᵢ₋₁, yᵢ₋₁, cᵢ₋₁) 3

In some examples, the attention based decoder subnetwork 314 may generate an attention-based text prediction 316 corresponding to each speech chunk 230. The attention-based text prediction 316 may be based on the posterior probabilities from the streaming attention subnetwork 308, represented by Pₐₜₜ(Y|X).

The CTC subnetwork 310 also is configured to receive the encoded text features 306 and classify the encoded text features using a CTC mechanism to generate a CTC-based text prediction 318 corresponding to each speech chunk 230. The CTC-based text prediction 318 corresponding to each speech chunk 230 may be based on the posterior probabilities from the CTC subnetwork 310, represented by P_{ctc}(Y|X).

During training of the online attention CTC neural network 303, a loss function may be used to optimize the attention-based text prediction 316 and the CTC-based text prediction 318 generated by the attention-based subnetwork 314 and the CTC subnetwork 310, where the loss function defined by:

L=λ log P_{ctc}(Y|X)+(1−λ)Pₐₜₜ(Y|X), 4

where λ is a tunable hyper-parameters that satisfies 0≤λ≤1.

The online attention CTC neural network 303 also includes a dynamic waiting joint decoding subnetwork 320 configured to receive the attention-based text prediction 316 and CTC-based text prediction 318 corresponding to each speech chunk 230 and generate a text transcript 240 corresponding to each speech chunk 230. The dynamic waiting joint decoding subnetwork 320 may assemble a final text transcript for a sequence of words from the attention-based text prediction 316 and the CTC-based text prediction 318. In some examples, the dynamic waiting joint decoding subnetwork 320 may convert each word from the final text transcript into a word embedding e_{j.}, with a sequence of word embeddings represented as E={e₁, . . . , e_{M}}, where M represents the number of words in the sequence of words. An example of dynamic waiting joint decoding subnetwork 320 is described in: Miao, Haoran, et al., “Online hybrid ctc/attention end-to-end automatic speech recognition architecture,” IEEE/ACM Transactions on Audio, Speech, and Language Processing 28 (2020): 1452-1465.

In some examples, since a speech chunk 230 may represent part of a word within an utterance of words in a speaker's speech, the text transcript 240 may be continuously updated as each new speech chunk 230 is received by the speech encoder 304 and propagated through the online attention CTC neural network 303 of the ASR module 220. The ASR module 220 may operate in an online mode, where speech processing and receiving operations may be conducted simultaneously. In this way, the ASR module 220 may not need to wait until an entire speech signal 210 representing a speaker's speech comprising one or more utterances to begin processing speech chunks 230 and generating text transcripts 240. In some examples, LSTM networks within the online attention CTC neural network 303 can store information in a memory and propagate past information forward to future time steps. In this way, the text prediction 240 is generated corresponding to each speech chunk 230 and updated for each subsequent speech chunk 230, the text transcript 240 initiating before the speech signal 210 representative of the speaker's speech comprises an entire utterance.

The online attention CTC neural network 303 provides monotonic alignment between the sequence of encoded text features 306 H and the output sequence of target class labels Y. The online attention CTC neural network 303 may enable local attention to be performed on each speech chunk 230 to more effectively distinguish between those speech chunks that relate to words or sequences of words that may be more relevant for the text prediction, while ignoring others. For a time tᵢ corresponding to an end point of a speech chunk 230, and yᵢ being a corresponding text prediction for a jth word that may be aligned in time with the speech chunk 230, the streaming attention subnetwork 308 may apply an attention mechanism by computing the probability, p_{i,j}, of selecting hⱼ for yᵢ within a moving forward window [h_{j-w+1}, hⱼ], where w is the width of a speech chunk.

Returning to FIG. 2, each speech chunk 230 and corresponding text transcript 240 generated by the ASR module 220 may be input to a Multimodal Language Understanding (MLU) module 250 to generate a semantic prediction 260.

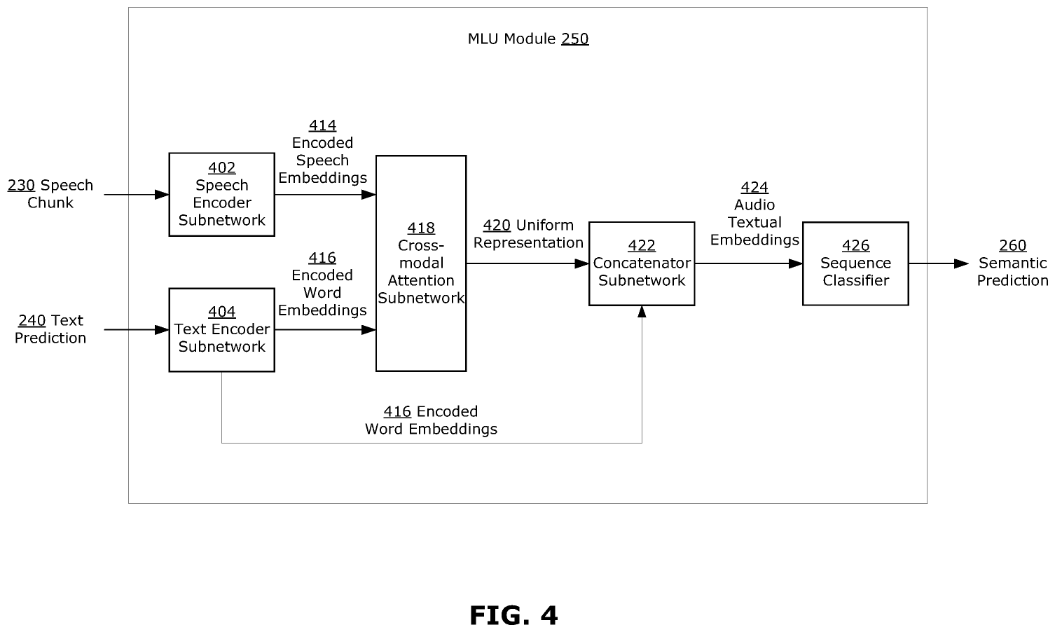

FIG. 4 is a block diagram illustrating an example of a Multimodal Language Understanding (MLU) module 250, in accordance the present disclosure. The MLU module 250 implements a neural network, such as a RNN, which includes a speech encoder subnetwork 302, a text encoder subnetwork 404, a cross-modal attention subnetwork 418 and the concatenator subnetwork 422, and sequence classifier 426. The speech encoder subnetwork 402 is configured to receive a speech chunk 230 from the ASR module 220 and generate an encoded representation of the speech chunk to model the sequential structure of the speech chunks 230. The speech chunk 230 may be represented as a speech embedding xᵢ. The encoded representation of the speech chunk may be a collection of encoded speech embeddings 414. The speech encoder subnetwork 402 may be a unidirectional LSTM. In some examples, the LSTM may incorporate time reduction operations along with a projection layer. The encoded speech embedding 414 may be denoted as sᵢ and may be represented as:

sᵢ=LSTM(xᵢ),i ∈{1, . . . T}, p ∈{1, . . . , P} 5

where sᵢ is the hidden state of the LSTM and P represents the length of the hidden state in the last layer of the LSTM after the time reduction operations.

The text encoder subnetwork 404 is configured to receive a text transcript 240 corresponding to a speech chunk 230 from the ASR module 220. The text transcript 240 may be received as a sequence of word embeddings E. In some examples, the text encoder subnetwork 404 may then encode the sequence of words and generate an encoded representation of the text prediction from the sequence of word embeddings E. The encoded representation of the text prediction may be a collection of encoded word embeddings 416. The hidden state hⱼ of the text encoder 404 encodes the jth word in the sequence of words and may be represented as:

hⱼ=LSTM(eⱼ), j ∈{1, . . . M}, 6

where M represents the number of words in the sequence of words. The text encoder subnetwork 404 may be a unidirectional LSTM, where the layers of the LSTM may be employed to capture temporal context from the text transcript 240.

The encoded speech embeddings 414 and encoded word embeddings 416 may then be input to the cross-modal attention subnetwork 418 which is configured to generate a uniform representation 420. The cross-modal attention subnetwork 418 may use an alignment mechanism to synchronize the encoded representation of the speech chunk (i.e. the encoded speech embeddings) and the encoded representation of the text prediction (i.e. the encoded word embeddings 316) and generate a uniform representation 420. The uniform representation 420 may enable information from different sources or in different formats and with independent, heterogeneous features to be assembled and used as if the information came from the same source. For example, since the encoded representation of the speech chunk and the encoded representation of the text prediction represent data from two modalities, the uniform representation 420 may provide a structure where the two sets of information can be merged for further processing. In some examples, the cross-modal attention subnetwork 418 may also use an attention mechanism to help identify which sequences of words may be more relevant in generating a semantic prediction 260.

Due to the nature of speech signals and the high number of speech chunks that may be associated with a few words in an utterance, compared to corresponding text transcripts of the corresponding words in the utterance, the dimensions of the encoded speech embeddings 414 may be larger than the dimensions of the encoded word embeddings 416. Synchronization of the encoded representation of the speech chunk and the encoded representation of the text prediction may include temporally aligning the encoded representation of the speech chunk for time step i with a corresponding encoded representation of the text prediction corresponding to the jth word in a sequence of words. In some examples, the alignment mechanism may be used to learn the alignment weights between the encoded speech embeddings 414 and the encoded word embeddings 416 in order to align the ith speech chunk 230 with the jth word in the sequence of words. The cross-modal attention subnetwork 418 may extract the attention weights from both modalities in order to project the encoded representation of the speech chunk into the text feature space to facilitate alignment. An example alignment mechanism that can be implemented in the cross-modal attention subnetwork 418 is described in: Xu, Haiyang, et al., “Learning alignment for multimodal emotion recognition from speech,” arXiv preprint arXiv:1909.05645 (2019). The attention weights between the encoded speech embeddings 414 and the encoded word embeddings 416 and the alignment of the ith speech chunk 230 with the jth word in the sequence of words may be obtained using the following equations:

$${a}_{j , i} = tanh ( {u}^{T} {s}_{i} + {v}^{T} {h}_{j} + b ) , \qquad 7$$

$${α}_{j , i} = \frac{{e}^{{a}_{j , i}}}{{\sum }_{t = 1}^{T} {e}^{{a}_{j , i}}} , \qquad 8$$

$${s}_{j} = {\sum }_{i} {α}_{j , i} {s}_{i} , \qquad 9$$

where u, v and b are parameters to be optimized during training of the the MLU module 250, α_{j,i} is the normalized attention weight for the sequence of words, and šⱼ is the weighted summation of hidden states from the speech encoder 402 and may be considered to represent the uniform representation 420, where the uniform representation 420 may be a collection of aligned speech embeddings in the form of an aligned speech vector corresponding to the ith word. Parameters of the MLU module 250 may be stored as data 118 in the memory 116 of the computing system 100.

The uniform representation 420 is input to a concatenator subnetwork 422 along with the encoded representation of the text prediction (for example, a collection of encoded word embeddings 416), where the uniform representation 420 and encoded representation of the text prediction may be concatenated to generate an audio-textual representation. The concatenator subnetwork 422 may be a unidirectional LSTM configured for multimodal feature fusion. The audio-textual representation may be a collection of audio-textual embeddings 424 obtained from the hidden state of the concatenator subnetwork 422 and may be represented as:

cᵢ=LSTM([šⱼ, cⱼ]), j ∈{1, . . . M}, 10

where M represents the number of words in the sequence of words.

The outputs of the cross-modal attention subnetwork 418 and concatenator subnetwork 422 together, namely the uniform representation 420 and the audio-textual embeddings 424, may constitute fused multimodal features, where fused multimodal features may be described as an integration of the features obtained from data of different modalities, (for example, speech and text), that provide enhanced features distinguished from feature extractors. In some examples, fusing multimodal features into a single joint representation enables the model to learn a joint representation of each of the modalities. In some examples, the audio-textual embeddings 424 may represent a joint representation of both speech and text modalities and may enable additional semantic information to be extracted from the speech modality to help to capture important semantic cues that are not present in the text transcript 240.

In some examples, a softmax operation may be used to transform the audio-textual embeddings 424 into a conditional probability distribution corresponding to each class from a predefined set of classes, for a sequence of semantic events at each time step. In some examples, a sequence classifier 426 may receive a sequence of semantic events and perform sequence classification by mapping the sequence of semantic events to a sequence of class labels. The probability values from the conditional probability distribution may be used to select the most likely class labels for the sequence of semantic events. In some examples, semantic events may overlap in time, therefore multiple class labels may be assigned for the same time step to facilitate extracting the user's intent for the one or more overlapping semantic events. In some examples, a semantic prediction 260 may be output as a sequence of predicted semantic events, the speaker's intent being incrementally captured in one or more semantic predictions 260 for each time step. The semantic prediction 260 may include a combination of slot events and intent events to facilitate capturing the user's intent.

In some examples, the sequence classifier 426 may support various alignment-free losses. In one example embodiment, a CTC method may be employed for sequence classification of an input sequence, such as the sequence of audio-textual embeddings 424. An example CTC method that can be implemented in example embodiments is described in: Graves, Alex, et al., “Connectionist temporal classification: labelling unsegmented sequence data with recurrent neural networks,” Proceedings of the 23rd international conference on Machine learning, 2006. The conditional probability of a single alignment is the product of the probabilities of observing a given label alignment at a time t, defined as:

P(α|X, θ)=Πₜ₌₁^{T}P(αₜ|X, θ), 11

where α represents a given label, X is the input sequence (for example, a sequence of speech chunks 230) and αₜ is a given class label at time t. These outputs may define the probabilities of all potential alignments of labels with the input sequence. The conditional probability for any one class label sequence is given by the sum of the probabilities of all of its corresponding potential alignments.

P(Y|X, θ)=ΣΠₜ₌₁^{T}P(αₜ|X, θ), 12

where Y is a predicted label sequence and A_{X,Y} is the set of all valid alignments. The CTC loss function L_{CTC} is then defined as:

L_{CTC}(X,Y)=−log 93 Πₜ₌₁^{T}P(αₜ|X, θ), 13

In another example embodiment, a Connectionist Temporal Localization (CTL) method may be employed by the sequence classifier 426 for sequence classification of an input sequence, such as the audio-textual embeddings 424 and localization of sequential semantic events. An example CTL method that can be implemented in example embodiments is described in: Wang, Yun, and Florian Metze, “Connectionist temporal localization for sound event detection with sequential labeling,” ICASSP 2019-2019 IEEE International Conference on Acoustics, Speech and Signal Processing (ICASSP), IEEE, 2019. In some examples, using a CTL method for sequence classification may allow for the prediction and localization of multiple overlapping events, where overlapping events may be defined as utterances that include multiple categories of semantic information spanning overlapping groups of words. For example, the prediction and localization of multiple overlapping events may improve intent extraction.

In some examples, boundary probabilities may be obtained from network event probabilities using a “rectified delta” operator in the CTL approach, which may ensure that the network predicts frame-wise probabilities of events rather than event boundaries. Prediction of frame-wise probabilities of event boundaries may introduce inconsistencies in predictions for different speech features. In some examples the boundary probabilities at each frame may be considered mutually independent in the CTL approach, which allows for the overlap of sound events. Assuming the independence of each frame may eliminate the need for a black symbol as employed in CTC approaches to emit nothing at a frame, as well as to separate repetition of the same label. In some examples, the CTL approach may imply that consecutive repeating labels are not collapsed. As a result, multiple labels may be applied at the same frame and a probability of emitting multiple labels at a frame t may be calculated, unlike CTC approaches.

Returning to FIG. 2, the sequence of semantic predictions 260 output by the MLU module 250 may be input to an interpreter 270 which is configured to transform one or more of the semantic predictions 260 into a command action 280 based on a predefined set of commands. The predefined set of commands may be stored as data 118 in the memory 116 of the computing system 100. A command action 280 may an action being taken by a computer or computer application, such as a digital assistant, in response to semantic predictions representing a speaker intent. For example, a command action 280 associated with the utterance “turn the lights on” would cause a computer device or computer application, which controls the lights of a room, to turn on the lights of the room.

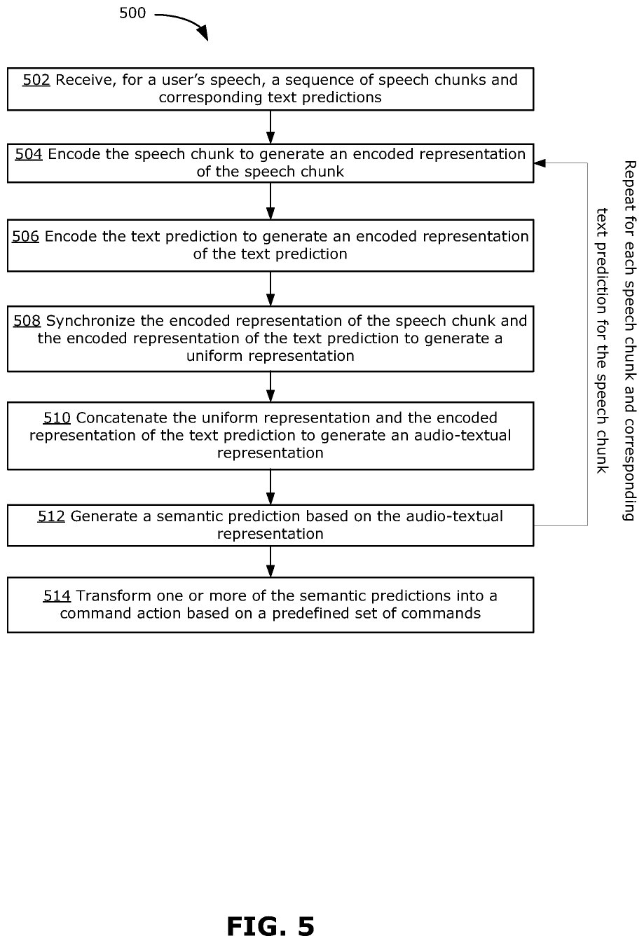

FIG. 5 is a flowchart illustrating an example method 500 for generating semantic predictions 260, in accordance with examples of the present disclosure. The method 500 may be performed by the computing system 100. The method 500 represents operations performed by the MLU module 250 depicted in FIG. 4. For example, the processor 102 may execute computer readable instructions 200-I (which may be stored in the memory 116) to cause the computing system 100 to perform the method 500.

Method 500 begins at step 502 in which a sequence of speech chunks 230 and corresponding text transcript 240 for a speech signal representative of a speaker speech, are received. The speech chunks 230 may have be generated from a speech signal 210 representative of a speaker's speech captured by a microphone 108 of the computing system 100 or another microphone on another electronic device. The text transcript 240 corresponding to a sequence of speech chunks 230 may be generated based on the speech chunks 230 using a hybrid CTC/attention mechanism and may be a sequence of word embeddings E.

The method 500 then proceeds to step 504. At step 504, each respective speech chunk 230 is encoded to generate an encoded representation of the respective speech chunk 230. In some examples, a speech chunk 230 may be a speech embedding xᵢ and the encoded representation of the speech chunk to model the sequential structure of the speech chunk 230. The encoded representation of the speech chunk may be a collection of encoded speech embeddings 414.

The method 500 then proceeds to step 504. At step 504, each text transcript 240 may be encoded to generate an encoded representation of the text prediction. In some examples, a text encoder 404 may receive the text transcript 240 as a sequence of word embeddings E and may generate an encoded representation of the text prediction to model the sequential structure of the sequence of words in a text transcript. The encoded representation of the text prediction may be a collection of encoded word embeddings 416.

The method 500 then proceeds to step 508. At step 508, the encoded representation of the speech chunk and the encoded representation of the text prediction may be synchronized, for example by the cross-modal attention subnetwork 418, to generate a uniform representation 420. Due to the nature of speech signals and the high volume of speech chuncks that may be associated with a few words in an utterance, compared to corresponding text transcripts of the corresponding words in the utterance, the dimensions of the encoded speech embeddings 414 may be larger than the dimensions of the encoded word embeddings 416. Therefore, synchronization of the encoded representation of the speech chunk and the encoded representation of the text prediction may include temporally aligning the encoded representation of the speech chunk for time step i with a corresponding encoded representation of the text prediction corresponding to the jth word in a sequence of words. In some examples, the cross-modal attention subnetwork 418 may receive the encoded speech embeddings 414 and encoded word embeddings 416 and use an alignment mechanism to learn the alignment weights a_{j,i} between the encoded speech embeddings 414 and the encoded word embeddings 416 in order to align the ith speech chunk 230 with the jth word in the sequence of words. The uniform representation 420 may a collection of aligned speech embeddings in the form of an aligned speech vector corresponding to the jth word.

The method 500 then proceeds to step 510. At step 510, the uniform representation 420 and the encoded representation of the text prediction (e.g. the encoded word embeddings 416) may be concatenated, for example, by the concatenator subnetwork 422 to generate an audio-textual representation. The audio-textual representation may be a collection of audio-textual embeddings 424. Using inputs from both the speech and text modality, the audio-textual representation may be a joint representation of both the speech and text modality.

In some examples, steps 508 and 510 may be described as performing a fusion of multimodal features. Feature fusion may be described as a method to integrate the features of different data to enhance the features distinguished from feature extractors. In the case of multimodal feature fusion, fusion of representations from different modalities (for example, speech and text) into a single representation enables the model to learn a joint representation of each of the modalities. In some examples, a benefit of using a joint representation of the modalities may be that additional semantic information may be extracted from the speech modality to help to capture important semantic cues that are not present in the text transcript 240.

The method 500 then proceeds to step 512. At step 512, a semantic prediction may be generated based on the audio-textual representation 424. In some examples, the audio-textual embeddings 424 are input to a softmax operator to transform the audio-textual embeddings 424 into a conditional probability distribution corresponding to each class, for a sequence of semantic events for each time step in a series of time steps. In some examples, a sequence classifier 426 receives a sequence of semantic events and performs sequence classification to generate a sequence of class labels. A loss function may be used to select the most likely class labels for the sequence of semantic events. In some examples, semantic events may overlap in time, therefore multiple class labels may be assigned for the same time step to facilitate extracting the user's intent for the one or more overlapping semantic events. In some examples, a semantic prediction 260 may be output as a sequence of predicted semantic events, the user's intent being incrementally captured in one or more semantic predictions 260 for each time step. The semantic prediction 260 may include a combination of slot events and intent events to facilitate capturing the user's intent.

Over a series of time steps, steps 504 through 512 of the method 500 may be repeated as each new speech chunk 230 and corresponding text transcript 240 are received and semantic predictions 260 are generated. When a sequence of semantic predictions 260 are sufficiently generated and recognized to contain a command, based on a pre-defined set of commands, the method 500 may proceed to step 514. In some examples, as each semantic prediction 260 is generated at a respective time step, the semantic prediction 260 may be stored in memory, for example memory 108.

At step 514, a sequence of semantic predictions 260 is transformed, for example by an interpreter 270 into a command action 280, based on a predefined set of commands. The predefined set of commands may be stored as data 118 in the memory 116 of the computing system 100. A command action 280 is an action to be taken by a computing device or a computer application, such as a digital assistant, representing a speaker's intent that may be delivered in the semantic prediction 260. For example, a command action 280 associated with the utterance “turn the lights on” would cause a computing device or computer application, which controls lights of a room to turn on the lights in the room.

In some examples, the streamable MLU system 200, including the cross-modal attention layer 418, the concatenator 422 and the sequence classifier 426 may be trained end-to-end using supervised learning. The ASR module 220, the speech encoder 402 and the text encoder 404 may be pre-trained separately. An Adam Optimizer may be utilized during training of the MLU module 250 to optimize the parameters of the subnetworks of the MLU module 250. An Adam Optimizer that can be used to train the streamable in example embodiments is described in: Kingma, Diederik P., and Jimmy Ba., “Adam: A method for stochastic optimization,” arXiv preprint arXiv:1412.6980 (2014).

A person of ordinary skill in the art may be aware that, in combination with the examples described in the embodiments disclosed in this disclosure, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

It should be understood that the disclosed systems and methods may be implemented in other manners. The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments. In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

The foregoing descriptions are merely specific implementations of this application, but are not intended to limit the protection scope of this disclosure. Any variation or replacement readily figured out by a person skilled in the art within the technical scope disclosed in this disclosure shall fall within the protection scope of this disclosure.

1. A method comprising:
receiving, for a speaker's speech, a sequence of speech chunks and corresponding text transcripts;
for each speech chunk and the corresponding text transcript for the speech chunk:
encoding the speech chunk to generate an encoded representation of the speech chunk;
encoding the text prediction to generate an encoded representation of the text transcript;
synchronizing the encoded representation of the speech chunk and the encoded representation of the text transcript to generate a uniform representation;
concatenating the uniform representation and the encoded representation of the text transcript to generate an audio-textual representation; and
generating a semantic prediction based on the audio-textual representation; and
transforming one or more of the semantic predictions into a command action based on a predefined set of commands.

2. The method of claim 1, wherein synchronizing the encoded representation of the speech chunk and the encoded representation of the text transcript comprises:
computing attention weights between the encoded representation of the speech chunk and the encoded representation of the text transcript based on an attention mechanism;
aligning the encoded representation of the speech chunk with a corresponding encoded representation of the text transcript based on the attention weights; and
concatenating the aligned encoded representation of the speech chunk and the corresponding encoded representation of the text transcript to generate the uniform representation.

3. The method of claim 1, wherein generating the semantic prediction based on the audio-textual representation comprises performing sequence classification on the audio-textual representation.

4. The method of claim 1, wherein generating the semantic prediction based on the audio-textual representation comprises performing sequence classification and localization on the audio-textual representation.

5. The method of claim 1, wherein each speech chunk in the sequence of speech chunks corresponds to a time step in a series of time steps.

6. The method of claim 1, comprising:
prior to receiving the sequence of speech chunks and corresponding text transcripts:
receiving a speech signal representative of the speaker's speech;
generating a sequence of speech chunks based on the speech signal;
encoding one or more encoded text features from each speech chunk;
processing the one or more encoded text features using an attention mechanism to generate an attention-based text prediction corresponding to each speech chunk;
processing the one or more encoded text features using connectionist temporal classification (CTC) to generate a CTC-based text prediction corresponding to each speech chunk; and
generating a text transcript corresponding to each speech chunk.

7. The method of claim 1, wherein the semantic prediction is generated and updated for each subsequent speech chunk before the speech signal representative to the speaker's speech comprises an entire utterance.

8. A computing system comprising:
one or more processors;
a memory storing machine-executable instructions, which, when executed by the one or more processors, cause the computing system to:
receive, for a speaker's speech, a sequence of speech chunks and corresponding text transcripts;
for each speech chunk and the corresponding text transcript for the speech chunk:
encode the speech chunk to generate an encoded representation of the speech chunk;
encode the text transcript to generate an encoded representation of the text prediction;
synchronize the encoded representation of the speech chunk and the encoded representation of the text transcript to generate a uniform representation;
concatenate the uniform representation and the encoded representation of the text transcript to generate an audio-textual representation; and
generate a semantic prediction based on the audio-textual representation; and
transform one or more of the semantic predictions into a command action based on a predefined set of commands.

9. The computing system of claim 8, wherein the machine-executable instructions, when executed by the one or more processors cause the computing system to synchronize the encoded representation of the speech chunk and the encoded representation of the text transcript by:
computing attention weights between the encoded representation of the speech chunk and the encoded representation of the text transcript based on an attention mechanism;
aligning the encoded representation of the speech chunk with a corresponding encoded representation of the text transcript based on the attention weights; and
concatenating the aligned encoded representation of the speech chunk and the corresponding encoded representation of the text transcript to generate the uniform representation.

10. The computing system of claim 8, wherein the machine-executable instructions, when executed by the one or more processors, further cause the system to generate a semantic prediction based on the audio-textual representation by performing sequence classification on the audio-textual representation.

11. The computing system of claim 8, wherein the machine-executable instructions, when executed by the one or more processors further cause the system to generate a semantic prediction based on the audio-textual representation by performing sequence classification and localization on the audio-textual representation.

12. The computing system of claim 8, wherein each speech chunk in the sequence of speech chunks corresponds to a time step in a series of time steps.

13. The computing system of claim 8, wherein the machine-executable instructions, when executed by the one or more processors, further cause the computing system to:
prior to receiving the sequence of speech chunks and corresponding text predictions:
receive a speech signal corresponding to the speaker's speech;
generate a sequence of speech chunks based on the speech signal;
encode one or more encoded text features from each speech chunk;
process the one or more encoded text features using an attention mechanism to generate an attention-based text prediction corresponding to each speech chunk;
process the one or more encoded text features using connectionist temporal classification (CTC) to generate a CTC-based text prediction corresponding to each speech chunk; and
generate a text prediction corresponding to each speech chunk.

14. The system of claim 8, the semantic prediction is generated and updated for each subsequent speech chunk before the speech signal representative to the speaker's speech comprises an entire utterance.

15. A non-transitory computer-readable medium having machine-executable instructions stored thereon which, when executed by one or more processors of a computing system, cause the computing system to:
receive, for a speaker's speech, a sequence of speech chunks and corresponding text transcripts;
for each speech chunk and the corresponding text transcript for the speech chunk:
encode the speech chunk to generate an encoded representation of the speech chunk;
encode the text transcript to generate an encoded representation of the text prediction;
synchronize the encoded representation of the speech chunk and the encoded representation of the text transcript to generate a uniform representation;
concatenate the uniform representation and the encoded representation of the text transcript to generate an audio-textual representation; and
generate a semantic prediction based on the audio-textual representation; and
transform one or more of the semantic predictions into a command action based on a predefined set of commands.

16. The non-transitory computer-readable medium of claim 15, wherein the machine-executable instructions, when executed by the one or more processors of the computing system cause the computing system to synchronize the encoded representation of the speech chunk and the encoded representation of the text transcript by:
computing attention weights between the encoded representation of the speech chunk and the encoded representation of the text transcript based on an attention mechanism;
aligning the encoded representation of the speech chunk with a corresponding encoded representation of the text transcript based on the attention weights; and
concatenating the aligned encoded representation of the speech chunk and the corresponding encoded representation of the text transcript to generate the uniform representation.

17. The non-transitory computer-readable medium of claim 16, wherein the machine-executable instructions, when executed by the one or more processor device to generate the semantic prediction by performing sequence classification on the audio-textual representation.

18. The non-transitory computer-readable medium of claim 16, wherein the machine-executable instructions, w when executed by the one or more processor device to generate the semantic prediction by performing sequence classification and localization on the audio-textual representation.

19. The non-transitory computer-readable medium of claim 16, wherein the machine-executable instructions, when executed by the one or more processors, further cause the computing system to:
prior to receiving the sequence of speech chunks and corresponding text predictions:
receive a speech signal corresponding to the speaker's speech;
generate a sequence of speech chunks based on the speech signal;
encode one or more encoded text features from each speech chunk;
process the one or more encoded text features using an attention mechanism to generate an attention-based text prediction corresponding to each speech chunk;
process the one or more encoded text features using connectionist temporal classification (CTC) to generate a CTC-based text prediction corresponding to each speech chunk; and
generate a text prediction corresponding to each speech chunk.

20. The non-transitory computer-readable medium of claim 16, wherein the semantic prediction is generated and updated for each subsequent speech chunk before the speech signal representative to the speaker's speech comprises an entire utterance.
